(19) United States
(12) Patent Application Publication
(10) Pub. No.: US 2020/0140663 A1
(43) Pub. Date: May 7, 2020

(54) RUBBER COMPOSITION FOR VIBRATIONPROOF RUBBER, VIBRATIONPROOF RUBBER, AND METHOD FOR PRODUCING RUBBER COMPOSITION FOR VIBRATIONPROOF RUBBER

(71) Applicant: Toyo Tire Corporation, Itami-shi (JP)

(72) Inventor: Norio Minouchi, Itami-shi (JP)

(73) Assignee: Toyo Tire Corporation, Itami-shi (JP)

(21) Appl. No.: 16/667,311

(22) Filed: Oct. 29, 2019

(30) Foreign Application Priority Data
Nov. 5, 2018 (JP) 2018-207990
Nov. 5, 2018 (JP) 2018-207993

(51) Int. Cl. C08L 7/02; C08K 3/04; C08K 5/00; C08K 5/20

(52) U.S. Cl. CPC C08L 7/02; C08K 3/04; C08L 2310/00; C08K 5/20; C08K 5/0025

(57) ABSTRACT

A rubber composition for vibrationproof rubber that comprises a natural rubber wet masterbatch comprising one or more natural rubbers and one or more carbon blacks in an amount of 5 to 100 parts by mass for 100 parts by mass of the natural rubber(s), and the rubber composition comprising a compound represented by the following formula (I) in an amount of 0.1 to 5 parts by mass when a total amount of one or more rubber components that is/comprise the natural rubber(s) is regarded as 100 parts by mass:

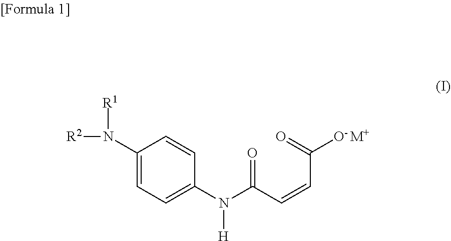

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

### BACKGROUND OF THE INVENTION

### Field of the Invention

The present invention relates to a rubber composition for vibrationproof rubber, particularly, a rubber composition for vibrationproof rubber that is favorably usable for a vibrationproof member, such as an engine mount for an automobile; a vibrationproof rubber; and a method for producing a rubber composition for vibrationproof rubber.

### Description of the Related Art

In vehicles, such as automobiles, a vibrationproof rubber is used to absorb the vibration of their engines or their vehicle bodies to improve the ride quality of the vehicles or prevent undesired sounds therefrom. In the vibrationproof rubber, the following are required to be compatible with each other at a high level: a decrease in the dynamic magnification (“dynamic spring constant”/“static spring constant” ratio) thereof; and an improvement in the permanent set-in fatigue resistance thereof. This dynamic magnification is an index of in-vehicle undesired sounds. As the dynamic magnification is lower, a better result is gained. Moreover, the permanent set-in fatigue resistance produces tap tones or other strange noises. Thus, as this property is also lower, a better result is gained.

In order to attain the above-mentioned purpose, Patent Document 1 discloses that while the particle diameter of a carbon black is optimized in a rubber composition for vibrationproof rubber, a rubber wet masterbatch is used which is yielded by mixing a natural rubber latex with a carbon-black-containing slurry in a liquid phase and then drying the mixture.

Patent Document 2 discloses that the dynamic magnification of a vibrationproof rubber is decreased by blending thereinto a thiosulfuric acid compound, such as S-(3-aminopropyl)thiosulfuric acid, or a salt thereof.

As a technique related to a rubber wet masterbatch, Patent Document 3 discloses a technique in which: when a carbon black is dispersed into a dispersing solvent, at least one portion of a natural rubber latex is added to this dispersion system to produce a carbon-black-containing slurry in which natural rubber latex particles adhere to the carbon black; the slurry is mixed, after the production, with the rest of the natural rubber latex; and then the mixture is solidified and dried.

According to Patent Document 4 listed below, an attempt is made for developing a vibrationproof rubber decreased in dynamic magnification by using, as a raw material, a rubber composition which contains a partially-modified rubber component and a carbon black having a specified property. However, there remains a room for improving the vibrationproof rubber from the viewpoint of a decrease of this rubber in dynamic magnification and an improvement thereof in endurance.

### PRIOR ART DOCUMENT

### Patent Document

Patent Document 1: JP-A-2009-292465
Patent Document 2: JP-A-2016-117843
Patent Document 3: Japanese Patent No. 4738551
Patent Document 4: JP-A-2006-193617

### SUMMARY OF THE INVENTION

In the light of the above-mentioned actual situation, the present invention has been made. An object thereof is to provide a rubber composition for vibrationproof rubber that is a raw material for a vibrationproof rubber capable of attaining the compatibility of a decreased dynamic magnification with an improved permanent set-in fatigue resistance; a method for producing the composition; and such a vibrationproof rubber. Another object of the invention is to provide a rubber composition for vibrationproof rubber that is a raw material for a vibrationproof rubber capable of attaining the compatibility of a decreased dynamic magnification with an improved endurance; and such a vibrationproof rubber.

In order to attain one of the objects, the inventor has found out that by blending a specified compound into a rubber composition containing a natural rubber wet masterbatch, a vulcanized rubber yielded from the rubber composition can attain the compatibility of a decreased dynamic magnification with an improved permanent set-in fatigue resistance. The present invention has been made as the results of the investigations to attain the object by the following:

Accordingly, the rubber composition for vibrationproof rubber according to a first aspect of the present invention is a rubber composition for vibrationproof rubber that includes a natural rubber wet masterbatch including one or more natural rubbers and one or more carbon blacks in an amount of 5 to 100 parts by mass for 100 parts by mass of the natural rubber(s), and

the rubber composition including a compound represented by the following formula (I) in an amount of 0.1 to 5 parts by mass when a total amount of one or more rubber components that is/include the natural rubber(s) is regarded as 100 parts by mass:

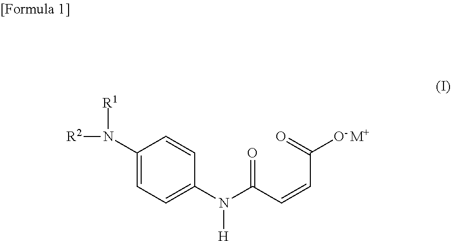

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

The rubber composition for vibrationproof rubber according to the first aspect of the present invention includes a natural rubber wet masterbatch including one or more natural rubbers and one or more carbon blacks in an amount of 5 to 100 parts by mass for 100 parts by mass of the natural rubber(s); and a compound represented by the formula (I). In general, when a natural rubber wet masterbatch is blended into a rubber composition for vibrationproof rubber, the resultant vulcanized rubber is made low in dynamic magnification. In the same way, also when a compound represented by the formula (I) is blended into a rubber composition for vibrationproof rubber, the resultant vulcanized rubber is made low in dynamic magnification. It had been however made evident that the case of blending, into a rubber composition for vibrationproof rubber, both of the natural rubber wet masterbatch and the compound represented by the formula (I) can produce a higher synergetic effect as comparted with the case of blending thereinto each of the wet masterbatch and the compound singly. The reason why this synergetic effect is gained is unclear; however, the reason would be as follows: in the natural rubber wet masterbatch, a carbon black is satisfactorily dispersed in advance within a rubber, and the compound represented by the formula (I) acts effectively onto this carbon black in the satisfactorily dispersed state; and by this effective action, the both-blended case can give the higher synergetic effect as compared with the single-blended case.

The rubber composition for vibrationproof rubber preferably includes the natural rubber(s) that is/are a natural rubber derived from the natural rubber wet masterbatch in a proportion of 10% or more by mass when the total amount of the rubber component(s) is regarded as 100% by mass. The rubber composition for vibrationproof rubber preferably includes the carbon black(s) that is/are a carbon black derived from the natural rubber wet masterbatch in a proportion of 15% or more by mass when the total amount of the carbon black(s) is regarded as 100% by mass. The present invention also relates to a vibrationproof rubber obtained by vulcanizing and molding the above-defined rubber composition for vibrationproof rubber. This vibrationproof rubber obtained by vulcanizing and molding the rubber composition for vibrationproof rubber attains the compatibility of a decreased dynamic magnification with an improved permanent set-in fatigue resistance.

The method according to the present invention for producing a rubber composition for vibrationproof rubber is a method for producing a rubber composition for vibrationproof rubber that includes a natural rubber wet masterbatch yielded by using, as raw materials, at least the following: one or more carbon blacks, a dispersing solvent, and a natural rubber latex solution, this method including a step (i) of adding, when the carbon black(s) is/are dispersed into the dispersing solvent, at least one portion of the natural rubber latex solution to the dispersing solvent to produce a carbon-black-containing slurry solution in which natural rubber latex particles adhere to the carbon black(s); a step (ii) of mixing the slurry solution with a rest of the natural rubber latex solution to produce a carbon-black-containing rubber latex solution in which the natural rubber latex particles adhere to the carbon black(s),

a step (iii) of solidifying and drying the carbon-black-containing rubber latex solution, in which the natural rubber latex particles adhere to the carbon black(s), to produce the natural rubber wet masterbatch, and a step (iv) of dry-mixing the natural rubber wet masterbatch with a blending agent that may be of various types. In this method, a compound represented by the following formula (I) is blended into the present rubber-composition-producing material-system in at least one of the steps (i) to (iv) in an amount of 0.1 to 5 parts by mass when a total amount of one or more rubber components that is/comprise one or more natural rubbers in the natural rubber wet masterbatch is regarded as 100 parts by mass:

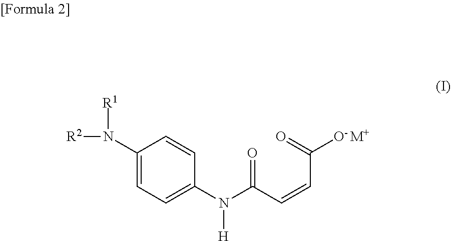

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

In this producing method, through the steps (i) to (iii), a natural rubber wet masterbatch is produced which is excellent, particularly, in carbon black dispersibility. Furthermore, in at least one of the steps (i) to (iv), the compound represented by the formula (I) is blended into the rubber-composition-producing material-system. In this way, the compound represented by the formula (I) acts more effectively onto the excellent dispersed-state carbon black. As a result, in the case of producing a vibrationproof rubber by using, as raw material, a rubber composition for vibrationproof rubber that is produced by the producing method according to the present invention, this vibrationproof rubber can attain the compatibility of a decreased dynamic magnification with an improved permanent set-in fatigue resistance at a higher level.

In order to attain the other of the above-mentioned objects, the present inventor has found out the following: by blending a specified compound into a rubber composition containing a natural rubber in a specified amount, a vulcanized rubber yielded from this rubber composition can attain the compatibility of a decreased dynamic magnification with an improved permanent set-in fatigue resistance. The present invention has been made as the results of the investigations to attain the object by the following:

In other words, the rubber composition for vibrationproof rubber according to a second aspect of the present invention includes one or more rubber components, in which when a total amount of the rubber component(s) is regarded as 100 parts by mass, a natural rubber is included in an amount of 60 parts or more by mass, and further a compound represented by the following formula (I) is included in an amount of 0.1 to 5 parts by mass:

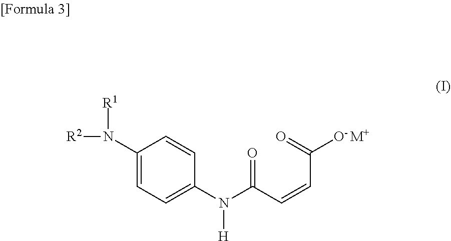

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

The present invention also relates to a vibrationproof rubber obtained by vulcanizing and molding the above-defined rubber composition for vibrationproof rubber.

When the total amount of the rubber component(s) is regarded as 100 parts by mass, the rubber composition for vibrationproof rubber according to the second aspect of the present invention contains the natural rubber in an amount of 60 parts or more by mass, and further contains the compound, which is represented by the formula (I), in an amount of 0.1 to 5 parts by mass; thus, a vulcanized rubber obtained by vulcanizing and molding the rubber composition for vibrationproof rubber finally attains the compatibility of a decreased dynamic magnification with an improved endurance.

### DETAILED DESCRIPTION OF THE PREFERRED EMBODIMENTS

The first aspect of the rubber composition for vibrationproof rubber according to the present invention includes a natural rubber wet masterbatch containing a carbon black, and a compound represented by the formula (I).

The natural rubber wet masterbatch is obtained by using, as raw material, a natural rubber latex solution containing at least the following as main components: one or more carbon blacks, a dispersing solvent, and a natural rubber latex. The natural rubber wet masterbatch can be produced by a known producing method, and may be a commercially available product thereof. In the present invention, it is preferred to use a natural rubber wet masterbatch produced though steps (i) to (iii) in a method described below for producing a rubber composition for vibrationproof rubber.

The carbon black may be any carbon black used in an ordinary rubber industry, such as an SAF class (ASTM No.: N100s), ISAF class (the same No.: N200s), HAF class (the same No.: 300s), FEF class (the same No.: N500s), GPF class (the same No.: N600s) or SRF class (the same No.: 700s) carbon black. The carbon black may be any granulated carbon black, which has been granulated, considering the handleability of the carbon black in an ordinary rubber industry; or a non-granulated carbon black.

The dispersing solvent is in particular preferably water. However, the dispersing solvent may be, for example, water containing an organic solvent.

The natural rubber latex solution is a natural product obtained by metabolic effect of a plant. Particularly preferred is a natural-rubber/water based latex solution in which a dispersing solvent is water. About the natural rubber in the natural rubber latex solution used in the first aspect of the invention, the number-average molecular weight thereof is preferably 2,000,000 or more, more preferably 2,500,000 or more. About the natural rubber latex solution, concentrated latex, fresh latex named field latex, and other latexes are usable without being distinguished from each other.

Hereinafter, a description will be specifically made about an example of the method for producing a rubber composition for vibrationproof rubber. This producing method includes a step (i) of adding, when one or more carbon blacks are dispersed into a dispersing solvent, at least one portion of a natural rubber latex solution to the dispersing solvent to produce a carbon-black-containing slurry solution in which natural rubber latex particles adhere to the carbon black(s); a step (ii) of mixing the slurry solution with a rest of the natural rubber latex solution to produce a carbon-black-containing rubber latex solution in which the natural rubber latex particles adhere to the carbon black(s); a step (iii) of solidifying and drying the carbon-black-containing rubber latex solution, in which the natural rubber latex particles adhere to the carbon black(s), to produce a natural rubber wet masterbatch; and a step (iv) of dry-mixing the natural rubber wet masterbatch with a blending agent that may be of various types.

### (1) Step (i)

In the step (i), when one or more carbon blacks are dispersed into a dispersing solvent, at least one portion of a natural rubber latex solution is added to the dispersing solvent to produce a carbon-black-containing slurry solution in which natural rubber latex particles adhere to the carbon black(s). It is allowable to mix the natural rubber latex solution beforehand with the dispersing solvent, and then add the carbon black(s) to the mixture to disperse the carbon black(s) in the mixture. It is also allowable to: add the carbon black(s) into the dispersing solvent; and next add the natural rubber latex solution thereto at a predetermined adding-speed and simultaneously disperse the carbon black(s) in the dispersing solvent. Alternatively, it is allowable to: add the carbon black(s) to the dispersing solvent; and next add thereto a predetermined volume of the natural rubber latex solution divided into several times and simultaneously disperse the carbon black(s) in the dispersing solvent. By dispersing the carbon black(s) into the dispersing solvent in the presence of the natural rubber latex solution, the slurry solution can be produced, which contains the carbon black(s) to which the natural rubber latex particles adhere.

In the step (i), the solid (rubber) content in the natural rubber latex solution to be added is preferably from 0.25 to 15%, more preferably from 0.5 to 6% by mass of the carbon black(s). The concentration of the solid (rubber) in the natural rubber latex solution to be added is preferably from 0.2 to 5% by mass, more preferably from 0.25 to 1.5% by mass. In these cases, a tire member can be produced in which the dispersion degree of the carbon black(s) is heightened while the natural rubber latex particles are surely caused to adhere to the carbon black(s). The concentration of the carbon black(s) in the slurry solution is not particularly limited, and may be, for example, from 1 to 20% by mass, or from 3 to 10% by mass.

In the step (i), the method for mixing the carbon black(s) with the dispersing solvent in the presence of the natural rubber latex solution is, for example, a method of dispersing the carbon black(s), using an ordinary dispersing machine such as a highly shearing mixer, a High Shear Mixer, a homo-mixer, a ball mill, a bead mill, a high-pressure homogenizer, an ultrasonic homogenizer or a colloid mill.

The “highly shearing mixer” means a mixer having a high-speed-rotatable rotor and a fixed stator in which in the state of making a precise clearance between the rotor and the stator, the rotor is rotated so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. An example thereof is a mixer, “High Shear Mixer”, manufactured by a company Silverson.

In the present invention, at the time of mixing the carbon black(s) with the dispersing solvent in the presence of the natural rubber latex solution to produce the carbon-black-containing slurry solution, in which the natural rubber latex particles adhere to the carbon black(s), a surfactant may be added thereto in order to improve the carbon black(s) in dispersibility. The surfactant may be a surfactant known in the rubber industry. Examples thereof include nonionic surfactants, anionic surfactants, cationic surfactants, and amphoteric surfactants. Instead of the surfactant or in addition to the surfactant, an alcohol such as ethanol may be used. However, when the surfactant is used, it is feared that the finally obtained vulcanized rubber is lowered in rubber physical properties. Thus, the blend amount of the surfactant is preferably 2 parts by mass or less, more preferably 1 part by mass or less for 100 parts by mass of the solid (rubber) content in the rubber latex solution. It is preferred not to use any surfactant substantially.

### (2) Step (ii)

In the step (ii), the slurry solution is mixed with the rest of the natural rubber latex solution to produce a carbon-black-containing rubber latex solution in which the natural rubber latex particles adhere to the carbon black(s). The method for mixing the slurry solution with the rest of the rubber latex solution in a liquid phase is not particularly limited, and may be a method of mixing the slurry solution with the rest of the rubber latex solution, using an ordinary dispersing machine such as a highly shearing mixer, a High Shear Mixer, a homo-mixer, a ball mill, a bead mill, a high-pressure homogenizer, an ultrasonic homogenizer or a colloid mill.

At the time of the mixing, the whole of the mixing system, for example, the dispersing machine may be optionally heated.

Considering the drying period and labor in the next step (iii), the solid (rubber) concentration in the rest of the natural rubber latex solution is preferably higher than that in the rubber latex solution added in the step (i). Specifically, the former solid (rubber) concentration is preferably from 10 to 60% by mass, more preferably from 20 to 30% by mass.

(3) Step (iii)

The step (iii) includes solidifying and drying the carbon-black-containing rubber latex solution, in which the natural rubber latex particles adhere to the carbon black(s), to produce a natural rubber wet masterbatch. The method for the solidification is, for example, a method of incorporating a solidifier into the carbon-black-containing rubber latex solution, in which the natural rubber latex particles adhere to the carbon black(s). In this case, the solidifier may be an acid or salt that is usually used to solidify a rubber latex solution, for example, formic acid, sulfuric acid or sodium chloride. About the drying, for example, a uniaxial extruder is used to heat the carbon-black-containing rubber solidified product at a temperature of 100 to 250° C. to dehydrate this solidified product while a shearing force is given to the solidified product.

As required after the step (iii), a drying step may be separately set up to decrease water content percentage in the natural rubber wet masterbatch. In the method for drying the natural rubber wet masterbatch, various drying machines are usable, examples thereof including a uniaxial extruder, an oven, a vacuum drier, and an air drier.

### (4) Step (iv)

The step (iv) includes dry-mixing the natural rubber wet masterbatch with a blending agent that may be of various types. The blending agent usable herein may be any blending agent used ordinarily in the rubber industry. Examples thereof include an additional rubber, an additional carbon black, a sulfur-based vulcanizer, a vulcanization promoter, an antiaging agent, silica, a silane coupling agent, zinc oxide, a methylene acceptor and a methylene donor, stearic acid, a vulcanization promotion aid, a vulcanization retarder, an organic peroxide, softeners such as wax and oil, and a working aid. The compound represented by the formula (I) may be blended in the step (iv), or may be blended in the steps (i) to (iii), in which the natural rubber wet masterbatch is produced. The compound represented by the formula (I) will be detailed later.

The rubber component(s) contained in the rubber composition for vibrationproof rubber of the first aspect of the present invention may be only a natural rubber derived from the natural rubber wet masterbatch. Separately from this natural rubber, one or more additional rubbers may be blended into the composition. However, when the total amount of the rubber component(s) is regarded as 100% by mass, the natural rubber derived from the natural rubber wet masterbatch is contained in the composition in a proportion that is preferably 10% by mass or more, more preferably 25% by mass or more, even more preferably 50% by mass or more, even more preferably 70% by mass or more. Examples of the additional rubber(s), which may be blended into the composition and is/are other than the natural rubber derived from the natural rubber wet masterbatch, include natural rubber (NR); or a diene-based synthetic rubbers such as isoprene rubber (IR), butadiene rubber (BR), styrene butadiene rubber (SBR), butyl rubber (IIR), and acrylonitrile butadiene rubber(NBR); halogenated butyl rubbers such as brominated butyl rubber (BR-IIR); and other synthetic rubbers such as polyurethane rubber, acrylic rubber, fluorine-contained rubber, silicone rubber, and chlorosulfonated polyethylene. It is preferred to use, as the additional rubber(s), out of these rubbers, at least one selected from the group consisting of natural rubber (NR), butadiene rubber (BR), and styrene butadiene rubber (SBR).

The carbon black(s) contained in the rubber composition for vibrationproof rubber of the first aspect of the present invention may be only the carbon black derived from the natural rubber wet masterbatch. Separately from this carbon black, one or more additional carbon blacks may be blended into the composition. However, when the total amount of the carbon black(s) is regarded as 100% by mass, the carbon black derived from the natural rubber wet masterbatch is contained in the composition in a proportion that is preferably 15% or more, more preferably 40% or more, in particular preferably 70% or more by mass. When the total amount of the carbon black(s) is regarded as 100% by mass in the same way, the proportion of the additional carbon black(s) is preferably 85% by mass or less, more preferably 60% by mass or less, in particular preferably 30% by mass or less. When the total amount of the rubber component(s) is regarded as 100 parts by mass, the total content of the carbon black(s) contained in the rubber composition for vibrationproof rubber according to the first aspect of the present invention is preferably from 20 to 100 parts by mass, more preferably from 25 to 80 parts by mass, in particular preferably from 30 to 60 parts by mass.

When the total amount of the rubber component(s) is regarded as 100 parts by mass, the rubber composition for vibrationproof rubber according to the first aspect of the present invention contains a compound represented by the following formula (I) in an amount of 0.1 to 5 parts by mass:

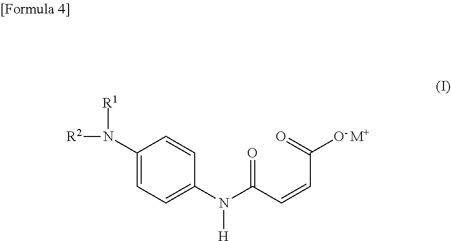

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

In order to make this compound high in affinity with the carbon black(s), it is particularly preferred to use a compound represented by the following formula (I′), in which, in the formula (I), R¹ and R² are each a hydrogen atom and M⁺ is a sodium ion:

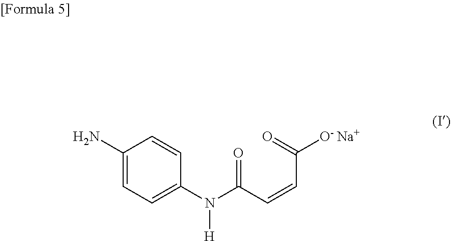

When the total amount of the rubber component(s) is regarded as 100 parts by mass, the content of the compound represented by the formula (I) is from 0.1 to 5 parts, preferably from 0.3 to 3 parts, in particular preferably from 0.5 to 2 parts by mass.

As far as the advantageous effects of the present invention are not damaged, a blending agent used ordinarily in the rubbery industry may be appropriately used and blended, together with the natural rubber wet masterbatch and the compound represented by the formula (I), into the rubber composition of the first aspect of the invention for vibrationproof rubber. Examples of the blending agent include an additional rubber, an additional carbon black, a sulfur-based vulcanizer, a vulcanization promoter, silica, a silane coupling agent, stearic acid, a vulcanization promotion aid, a vulcanization retardant, an antiaging agent, softeners such as wax and oil, and a working aid.

The rubber composition for vibrationproof rubber according to the first aspect of the present invention preferably includes a sulfur-based vulcanizer. The sulfur as this sulfur-based vulcanizer is sufficient to be a sulfur for ordinary rubbers, and may be, for example, powdery sulfur, precipitated sulfur, insoluble sulfur, or highly dispersible sulfur. In the rubber composition for vibrationproof rubber according to the first aspect of the invention, the sulfur content is preferably from 0.2 to 5 parts, more preferably from 0.5 to 3 parts by mass for 100 parts by mass of the rubber component(s), considering the dynamic magnification and the heat resistance of a vibrationproof rubber to be produced from the composition.

The vulcanization promoter may be a vulcanization promoter usable ordinarily for vulcanizing rubbers. Examples thereof include sulfenamide type, thiuram type, thiazole type, thiourea type, guanidine type, and dithiocarbamic acid salt type vulcanization promoters. These may be used singly or in the form of an appropriate mixture. The use of the sulfenamide type vulcanization promoter is preferred to lower the dynamic magnification of the vibrationproof rubber to be produced. The blend amount of the vulcanization promoter is preferably from 0.1 to 5 parts, more preferably from 0.2 to 3 parts by mass for 100 parts by mass of the rubber component(s).

The antiaging agent may be an antiaging agent usable usually for rubbers, examples thereof including aromatic amine type, amine-ketone type, monophenolic type, bisphenolic type, polyphenolic type, dithiocarbamic acid salt type, and thiourea type antiaging agents. These may be used singly or in the form of an appropriate mixture.

The rubber composition of the first aspect of the present invention for vibrationproof rubber can be yielded by using a mixing machine used in an ordinary rubber industry, such as a Banbury mixer, a kneader or a roll, to mix and knead a natural rubber wet masterbatch, and a compound represented by the formula (I) together with, for example, one or more blending agents used ordinarily in the rubber industry, such as a sulfur-based vulcanizer, a vulcanization promoter, silica, a silane coupling agent, stearic acid, a vulcanization promotion aid, a vulcanization retardant, an antiaging agent, softeners such as wax and oil, and/or a working aid.

The method for blending the above-mentioned individual components is not particularly limited, and may be, for example, any one of the following: a method of kneading, in advance, components other than the sulfur-based vulcanizer, the vulcanization promoter and other vulcanization-related components to prepare a masterbatch, adding the remaining components thereto, and further kneading the resultant; a method of adding the individual components in any order, and then kneading the resultant; and a method of adding all the components simultaneously, and kneading the resultant.

After the individual components are kneaded and then the resultant is molded, the molded body is vulcanized. In this way, a vibrationproof rubber can be produced which attains the compatibility of a decreased dynamic magnification with an improved endurance. The vulcanizing temperature may be, for example, from 120 to 200° C., and is preferably from 140 to 180° C.

Specific examples of an application of the vibrationproof rubber according to the present embodiment include various vibrationproof rubbers for automobiles, such as engine mount, strut mount, body mount, cab mount, member mount, differential mount, and other mount rubbers; suspension bush, arm bush, torque bush and other bush rubbers; and torsional dumper, muffler hanger, dumper pulley, dynamic dumper rubbers. Moreover, the vibrationproof rubber can be favorably applied not only to such automobile rubbers but also to vibrationproof rubbers for rail trains, vibrationproof rubbers for industrial machines, seismic isolation rubbers for buildings, seismic isolation rubber bearings or supports, and other vibrationproof rubbers or seismic isolation rubbers.

The rubber composition for vibrationproof rubber according to the second aspect of the present invention includes one or more rubber components, in which when a total amount of the rubber component(s) is regarded as 100 parts by mass, a natural rubber is included in an amount of 60 parts or more by mass, and further a compound represented by the following formula (I) is included in an amount of 0.1 to 5 parts by mass.

The rubber composition for vibrationproof rubber according to the second aspect of the present invention includes one or more rubber components; and when the total amount of the rubber component(s) is regarded as 100 parts by mass, the rubber composition includes a natural rubber in an amount of 60 parts or more by mass. This rubber composition for vibrationproof rubber may contain a diene-based rubber other than the natural rubber. Examples thereof include diene-based synthetic rubbers such as isoprene rubber (IR), butadiene rubber (BR), styrene butadiene rubber (SBR), butyl rubber (IIR), and acrylonitrile butadiene rubber(NBR); halogenated butyl rubbers such as brominated butyl rubber (BR-IIR); and other synthetic rubbers such as polyurethane rubber, acrylic rubber, fluorine-contained rubber, silicone rubber, and chlorosulfonated polyethylene.

The rubber composition for vibrationproof rubber according to the second aspect of the present invention preferably contains a carbon black. In general, when a vibrationproof rubber is made low in dynamic magnification, a technique is used in which a carbon black large in particle diameter, which is not ordinarily used, is blended into the rubber. However, this technique tends to deteriorate the vibrationproof rubber in endurance. In the present invention, however, the compound represented by the formula (I) is incorporated into the natural rubber, the proportion of which is specified in the rubber component(s), in an amount of 0.1 to 5 parts by mass. Thus, even when an ordinarily usable carbon black is used in the present invention, the resultant vibrationproof rubber can realize a decrease in dynamic magnification, and further this rubber can also be improved in endurance.

The carbon black may be any carbon black used in an ordinary rubber industry, such as an SAF class (ASTM No.: N100s), ISAF class (the same No.: N200s), HAF class (the same No.: 300s), FEF class (the same No.: N500s), GPF class (the same No.: N600s) or SRF class (the same No.: 700s) carbon black. The carbon black may be any granulated carbon black, which has been granulated, considering the handleability of the carbon black in an ordinary rubber industry; or a non-granulated carbon black.

In the second aspect of the present invention, it is preferred to use, out of the above-mentioned carbon blacks, at least one carbon black selected from the group consisting of HAF class, FEF class, and GPF class carbon blacks, which are ordinarily used. Moreover, in the case of considering rubber physical properties of the finally obtained vulcanized rubber, the carbon black content in the rubber composition is from 10 to 100 parts, more preferably from 20 to 70 parts by mass when the total amount of the rubber component(s) in the rubber composition is regarded as 100 parts by mass.

The compound represented by the formula (I) can be represented by the following structural formula:

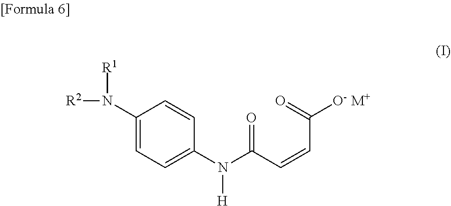

in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

In order to make this compound high in affinity with the carbon black, it is particularly preferred to use a compound represented by the following formula (I′), in which, in the formula (I), R¹ and R² are each a hydrogen atom and M⁺ is a sodium ion:

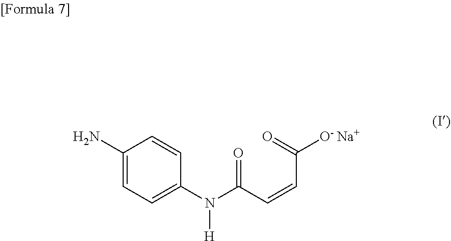

When the total amount of the rubber component(s) is regarded as 100 parts by mass, the content of the compound represented by the formula (I) is from 0.1 to 5 parts, preferably from 0.3 to 3 parts, in particular preferably from 0.5 to 2 parts by mass.

As far as the advantageous effects of the present invention are not damaged, any blending agent used ordinarily in the rubber industry may be appropriately used and blended, together with the above-mentioned rubber component(s), the compound represented by the formula (I) and the carbon black, into the rubber composition for vibrationproof rubber. Examples of the blending agent include a sulfur-based vulcanizer, a vulcanization promoter, silica, a silane coupling agent, stearic acid, a vulcanization promotion aid, a vulcanization retardant, an antiaging agent, softeners such as wax and oil, and a working aid.

The rubber composition for vibrationproof rubber according to the first aspect of the present invention preferably includes a sulfur-based vulcanizer. The sulfur as this sulfur-based vulcanizer is sufficient to be a sulfur for ordinary rubbers, and may be, for example, powdery sulfur, precipitated sulfur, insoluble sulfur, or highly dispersible sulfur. In the rubber composition for vibrationproof rubber according to the first aspect of the invention, the sulfur content is preferably from 0.2 to 5 parts, more preferably from 0.5 to 3 parts by mass for 100 parts by mass of the rubber component(s), considering the dynamic magnification and the heat resistance of a vibrationproof rubber to be produced from the composition.

The vulcanization promoters may each be a vulcanization promoter usable ordinarily for vulcanizing rubbers. Examples thereof include sulfenamide type, thiuram type, thiazole type, thiourea type, guanidine type, and dithiocarbamic acid salt type vulcanization promoters. These may be used singly or in the form of an appropriate mixture. The use of the sulfenamide type vulcanization promoter is preferred to lower the dynamic magnification of the vibrationproof rubber to be produced. The blend amount of the vulcanization promoter is preferably from 0.1 to 5 parts, more preferably from 0.2 to 3 parts by mass for 100 parts by mass of the rubber component(s).

The antiaging agents may each be an antiaging agent usable usually for rubbers, examples thereof including aromatic amine type, amine-ketone type, monophenolic type, bisphenolic type, polyphenolic type, dithiocarbamic acid salt type, and thiourea type antiaging agents. These may be used singly or in the form of an appropriate mixture.

The rubber composition for vibrationproof rubber of the second aspect of the present invention can be yielded by using a mixing machine used in an ordinary rubber industry, such as a Banbury mixer, a kneader or a roll, to mix and knead one or more rubber components as described above, a compound represented by the formula (I), and a carbon black, together with, for example, one or more blending agents used ordinarily in the rubber industry. Examples of the agent(s) include a sulfur-based vulcanizer, a vulcanization promoter, silica, a silane coupling agent, stearic acid, a vulcanization promotion aid, a vulcanization retardant, an antiaging agent, softeners such as wax and oil, and a working aid.

The method for blending the above-mentioned individual components is not particularly limited, and may be, for example, any one of the following: a method of kneading, in advance, components other than the sulfur-based vulcanizer, the vulcanization promoter and other vulcanization-related components to prepare a masterbatch, adding the remaining components thereto, and further kneading the resultant; a method of adding the individual components in any order, and then kneading the resultant; and a method of adding all the components simultaneously, and kneading the resultant.

After the individual components are kneaded and then the resultant is molded, the molded body is vulcanized. In this way, a vibrationproof rubber can be produced which attains the compatibility of a decreased dynamic magnification with an improved endurance. The vulcanizing temperature may be, for example, from 120 to 200° C., and is preferably from 140 to 180° C.

Specific examples of an application of the vibrationproof rubber according to the present embodiment include various vibrationproof rubbers for automobiles, such as engine mount, strut mount, body mount, cab mount, member mount, differential mount, and other mount rubbers; suspension bush, arm bush, torque bush and other bush rubbers; and torsional dumper, muffler hanger, dumper pulley, dynamic dumper rubbers. Moreover, the vibrationproof rubber can be favorably applied not only to such automobile rubbers but also to vibrationproof rubbers for rail trains, vibrationproof rubbers for industrial machines, seismic isolation rubbers for buildings, seismic isolation rubber bearings or supports, and other vibrationproof rubbers or seismic isolation rubbers.

### EXAMPLES

Hereinafter, the present invention will be more specifically described through descriptions about working examples of the invention.

### (Preparation of Each Rubber Composition)

In accordance with a blending formulation in Table 1, rubber components in each of Examples 1 to 6, and Comparative Examples 1 to 4 were blended into 100 parts by weight of a rubber component. An ordinary Banbury mixer was then used to knead the resultant to prepare a rubber composition. The individual blending agents described in Table 1 are as follows:

Natural rubber (NR): “RSS #3”;

Compound represented by the general formula (I) (sodium (2Z)-4-[(4-aminophenyl)amino]-4-oxo-2-butenoate): “SUMILINK 200”, manufactured by Sumitomo Chemical Co., Ltd.;

Carbon black FEF (N550): “SEAST SO”, manufactured by Tokai Carbon Co., Ltd.;

Carbon black HAF (N339): “SEAST KH”, manufactured by Tokai Carbon Co., Ltd.;

Zinc oxide: “Zinc Oxide, Type I”, manufactured by Mitsui Mining & Smelting Co., Ltd.;

Stearic acid: “LUNAC S20”, manufactured by Kao Corp.;

Wax: “OZOACE 2701”, manufactured by Nippon Seiro Co., Ltd.);

Antiaging agent 6C: “SANTOFLEX 6PPD”, manufactured by Flexsys Inc.;

Antiaging agent RD: “NOCRAC 224”, manufactured by Ouchi Shinko Chemical Industrial Co., Ltd.;

Sulfur: “Powdery Sulfur for Rubber, 150-Mesh”, manufactured by Hosoi Chemical Industry Co., Ltd.;

Vulcanization promoter CZ: “NOCCELER DM-P”, manufactured by Ouchi Shinko Chemical Industrial Co., Ltd.; and

Vulcanization promoter TS: “SANCELER TS”, manufactured by Sanshin Chemical Industry Co., Ltd.

### Examples 1 to 6, and Comparative Example 3

In each of the examples, a natural rubber concentrated latex (dry rubber content: 60%) manufactured by REGITEX was used. A carbon black was added to a diluted solution of the natural rubber latex, this solution having an adjusted concentration of 0.5% by mass, to give a blend amount shown in Table 1 (the concentration of the carbon black in water was 1% by mass). Thereto was dispersed the carbon black, using a machine ROBOMIX manufactured by Primix Corp. (ROBOMIX conditions: 9000 rpm for 30 minutes). In this way, a carbon-black-containing slurry solution was produced in which natural rubber latex particles adhered to the carbon black (step (i)). Next, a natural rubber latex solution (25% by mass) was added to the carbon-black-containing slurry solution produced through the step (i), in which the natural rubber latex particles adhered to the carbon black, to give a blend amount shown in Table 1. Next, a mixer for home use, SM-L56 model, manufactured by SANYO Electric Co., Ltd. was used to mix these components with each other (mixer conditions: 11300 rpm for 30 minutes) to produce a carbon-black-containing rubber latex solution in which the natural rubber latex particles adhered to the carbon black (step (ii)).

Formic acid (10% by mass) as a solidifier was added to the carbon-black-containing natural rubber latex solution yielded through the step (ii), in which the natural rubber latex particles adhered to the carbon black, until the whole of the solution turned into a pH of 4, so as to produce a carbon-black-containing natural rubber solidified product. Next, the product was charged into a screw press, V-01 model, manufactured by Suehiro EPM Corp., and dried to produce a natural rubber wet masterbatch (GMB-1 or GMB-2) (step (iii)).

Into the resultant natural rubber wet masterbatch were added various blending agents including a compound represented by the formula (I), and a Banbury mixer was used to dry-mix these components with each other to produce a rubber composition (step (iv)). In Table 1, the blend proportion of each of the components is represented by the numerical value of parts by mass (phr) when the total amount of the corresponding rubber component was regarded as 100 parts by mass.

### Comparative Examples 1, 2, 4 and 5

In each of the examples, a rubber composition was produced by: blending a natural rubber, a carbon black, a compound represented by the formula (I), and various blending agents into each other instead of the use of the natural rubber wet masterbatch; and using a Banbury mixer to dry-mix these components with each other.

Each of the resultant vulcanized rubbers was evaluated in accordance with evaluating criteria described below.

### [Dynamic Magnification]

About a sample (50 mm in diameter×25 mm) of the vulcanized rubber, which was obtained by using a predetermined mold to vulcanize the each of the rubber compositions at 150° C. for 25 minutes, the static spring constant Ks and the dynamic spring constant Kd thereof were measured by a method described below, and the ratio therebetween (Kd/Ks ratio) was calculated. In this way, the dynamic magnification of the sample was gained. About each of Examples 1 to 4, and Comparative Example 2, the result thereof was represented as an index relative to the result of Comparative Example 1, which was regarded as 100, to make index evaluations. About each of Examples 5 and 6, and Comparative Example 5, the result thereof was represented as an index relative to the result of Comparative Example 4, which was regarded as 100, to make index evaluations. It is meant that as the index is smaller, the vulcanized rubber is lower in dynamic magnification to be better in dynamic properties.

Static spring constant (Ks): Tensilon, manufactured by Orientec Co., Ltd. was used as a measuring instrument to repeat, two times, a compression (compression down to 20%) of a sample of the vulcanized rubber between 0 and 5 mm at a cross head speed of 10 mm/minute. At the second compression, a load-flexure chart of the sample was drawn, and then the static spring constant was calculated in accordance with the following equation:

Static spring constant (N/mm)=(w2−w1)/(δ2−δ1)

in which w1 is a load (N) applied when the flexure quantity δ1 is 1.3 mm, and w2 is a load (N) applied when the flexure quantity δ2 is 3.8 mm.

Dynamic Spring constant (Kd): Dynamic Servo, manufactured by Saginomiya Seisausho, Inc. was used as a measuring instrument to make a measurement at an initial strain (compression) of 10%, a frequency of 100 Hz, and an amplitude of ±0.05 mm (±0.2%). The dynamic spring constant (unit: N/mm) was then gained in accordance with JIS K 6394.

### [Permanent Set-in Fatigue Resistance]

In accordance with JIS K 6262, the permanent set-in fatigue resistance (CS (%)) of the vulcanized rubber was evaluated (at 100° C. over 250 hours). About the evaluation of each of Examples 1 to 4, and Comparative Example 2, the result thereof was represented as an index relative to the result of Comparative Example 1, which was regarded as 100, to make index evaluations. About each of Examples 5 and 6, and Comparative Example 5, the result thereof was represented as an index relative to the result of Comparative Example 4, which was regarded as 100, to make index evaluations. It is meant that as the index is smaller, the vulcanized rubber is better in permanent set-in fatigue resistance.

TABLE 1

| Compar- | Compar- | Compar- | | | | | Compar- | Compar- | | |
|---|---|---|---|---|---|---|---|---|---|---|
| ative | ative | ative | | | | | ative | ative | | |
| Example | Example | Example | Example | Example | Example | Example | Example | Example | Example | Example |
| 1 | 2 | 3 | 1 | 2 | 3 | 4 | 4 | 5 | 5 | 6 |

(Blend)

| | | | | | | | | | | | |
|---|---|---|---|---|---|---|---|---|---|---|---|
| NR | 100 | 100 | | | | | | 100 | 100 | | |
| GMB-1 | | | 145 | 145 | 145 | 145 | 145 | | | | |
| (containing 45 | | | | | | | | | | | |
| parts by | | | | | | | | | | | |
| mass of FEF) | | | | | | | | | | | |
| GMB-2 | | | | | | | | | | 135 | 135 |
| (containing 35 | | | | | | | | | | | |
| parts by | | | | | | | | | | | |
| mass of HAF) | | | | | | | | | | | |
| CB FEF (N550) | 50 | 50 | | | 5 | 5 | 5 | | | | |
| CB MAF (N550) | | | | | | | | 40 | 40 | 5 | 5 |
| Compound | | 1.5 | | 0.2 | 0.6 | 1 | 3 | | 1 | 0.6 | 2 |
| represented by | | | | | | | | | | | |
| formula (I) | | | | | | | | | | | |
| Zinc oxide | 5 | 5 | 5 | 5 | 5 | 5 | 5 | 5 | 5 | 5 | 5 |
| Stearic acid | 2 | 2 | 2 | 2 | 2 | 2 | 2 | 2 | 2 | 2 | 2 |
| Wax | 1.5 | 1.5 | 1.5 | 1.5 | 1.5 | 1.5 | 1.5 | 1.5 | 1.5 | 1.5 | 1.5 |
| Antiaging | 2 | 2 | 2 | 2 | 2 | 2 | 2 | 2 | 2 | 2 | 2 |
| agent 6C | | | | | | | | | | | |
| Antiaging | 1 | 1 | 1 | 1 | 1 | 1 | 1 | 1 | 1 | 1 | 1 |
| agent RD | | | | | | | | | | | |
| Sulfur | 0.8 | 0.8 | 0.8 | 0.8 | 0.8 | 0.8 | 0.8 | 0.8 | 0.8 | 0.8 | 0.8 |
| Vulcanization | 2 | 2 | 2 | 2 | 2 | 2 | 2 | 2 | 2 | 2 | 2 |
| promoter CZ | | | | | | | | | | | |
| Vulcanization | 0.5 | 0.5 | 0.5 | 0.5 | 0.5 | 0.5 | 0.5 | 0.5 | 0.5 | 0.5 | 0.5 |
| promoter TS | | | | | | | | | | | |

(Evaluations)

| | | | | | | | | | | | |
|---|---|---|---|---|---|---|---|---|---|---|---|
| Dynamic | 100 | 95 | 94 | 92 | 90 | 88 | 85 | 100 | 96 | 92 | 88 |
| magnification | | | | | | | | | | | |
| Permanent | 100 | 102 | 100 | 98 | 95 | 90 | 88 | 100 | 101 | 95 | 90 |
| set-in fatigue | | | | | | | | | | | |
| resistance | | | | | | | | | | | |

The results are as shown in Table 1. In Comparative Example 2, which was yielded by dry-mixing the natural rubber, the carbon black, the compound represented by the formula (I), and the various blending agents, and in Comparative Example 3, which was yielded by using the natural rubber wet masterbatch, but using no compound represented by the formula (I), the dynamic magnification was made lower but the permanent set-in fatigue resistance was not made better than in Comparative Example 1, which was a control. By contrast, in Examples 1 to 4, each of which was yielded by using both of the natural rubber wet masterbatch and the compound represented by the formula (I), the permanent set-in fatigue resistance was made remarkably better and further the dynamic magnification was made remarkably lower than in Comparative Examples 2 and 3. It is understood that Examples 5 and 6, in each of which the carbon black was changed from that in Examples 1 to 4, also produced the same advantageous effects.

Hereinafter, the present invention will be more specifically described through descriptions about working examples of the invention.

### (Preparation of Each Rubber Composition)

In accordance with a blending formulation in Table 2, rubber composition in each of Examples 7 to 12, and Comparative Examples 6 and 7 were blended into 100 parts by weight of a rubber component. An ordinary Banbury mixer was then used to knead the resultant to prepare a rubber composition. The individual blending agents shown in Table 2 are as follows:

Natural rubber (NR): “RSS #3”;

BR: Butadiene rubber, “BUNA CB22”, manufactured by Lanxess AG.

Compound represented by the general formula (I) (sodium (2Z)-4-[(4-aminophenyl)amino]-4-oxo-2-butenoate): “SUMILINK 200”, manufactured by Sumitomo Chemical Co., Ltd.;

Carbon black FEF (N550): “SEAST SO”, manufactured by Tokai Carbon Co., Ltd.;

Carbon black HAF (N339): “SEAST KH”, manufactured by Tokai Carbon Co., Ltd.;

Zinc oxide: “Zinc Oxide, Type I”, manufactured by Mitsui Mining & Smelting Co., Ltd.;

Stearic acid: “LUNAC S20”, manufactured by Kao Corp.;

Wax: “OZOACE 2701”, manufactured by Nippon Seiro Co., Ltd.);

Antiaging agent 6C: “SANTOFLEX 6PPD”, manufactured by Flexsys Inc.;

Antiaging agent RD: “NOCRAC 224”, manufactured by Ouchi Shinko Chemical Industrial Co., Ltd.;

Sulfur: “Powdery Sulfur for Rubber, 150-Mesh”, manufactured by Hosoi Chemical Industry Co., Ltd.;

Vulcanization promoter CZ: “NOCCELER DM-P”, manufactured by Ouchi Shinko Chemical Industrial Co., Ltd.; and

Vulcanization promoter TS: “SANCELER TS”, manufactured by Sanshin Chemical Industry Co., Ltd.

### Examples 7 to 12, and Comparative Examples 6 and 7

In each of the examples, a Banbury mixer was used to add/mix components except any sulfur, any vulcanization promoter and any vulcanization retardant to/with each other initially in accordance with a blend formulation (parts by mass) shown in Table 2 described below at a first mixing stage (the component-discharging temperature at the mixing time: 160° C.), and then sulfur, and a vulcanization promoter were added/mixed to/with the resultant mixture at a final mixing stage to prepare a rubber composition for vibrationproof rubber. About each of the rubber compositions, a vulcanized rubber was produced therefrom and then properties thereof were evaluated.

Each of the resultant vulcanized rubbers was evaluated in accordance with evaluating criteria described below.

### [Dynamic Magnification]

About a sample (50 mm in diameter×25 mm) of the vulcanized rubber, which was obtained by using a predetermined mold to vulcanize the each of the rubber compositions at 150° C. for 25 minutes, the static spring constant Ks and the dynamic spring constant Kd thereof were measured by a method described below, and the ratio therebetween (Kd/Ks ratio) was calculated. In this way, the dynamic magnification of the sample was gained. About each of Examples 1 to 4, and Comparative Example 1, the result thereof was represented as an index relative to the result of Comparative Example 1, which was regarded as 100, to make index evaluations. About each of Examples 5 and 6, the result thereof was represented as an index relative to the result of Comparative Example 2, which was regarded as 100, to make index evaluations. It is meant that as the index is smaller, the vulcanized rubber is lower in dynamic magnification to be better in dynamic properties.

Static spring constant (Ks): Tensilon, manufactured by Orientec Co., Ltd. was used as a measuring instrument to repeat, two times, a compression (compression down to 20%) of a sample of the vulcanized rubber between 0 and 5 mm at a cross head speed of 10 mm/minute. At the second compression, a load-flexure chart of the sample was drawn, and then the static spring constant was calculated in accordance with the following equation:

Static spring constant (N/mm)=(w2−w1)/(δ2−δ1)

in which w1 is a load (N) applied when the flexure quantity δ1 is 1.3 mm, and w2 is a load (N) applied when the flexure quantity δ2 is 3.8 mm.

Dynamic Spring constant (Kd): A product, Dynamic Servo, manufactured by Saginomiya Seisausho, Inc. was used as a measuring instrument to make a measurement at an initial (compression) strain of 10%, a frequency of 100 Hz, and an amplitude of ±0.05 mm (±0.2%). The dynamic spring constant (unit: N/mm) was then gained in accordance with JIS K 6394.

### [Endurance]

Each of the rubber compositions was transfer-molded into a predetermined columnar structure (30 in diameter×20 in height). The resultant was inclined by 550. An upward and downward constant-load vibration (upward direction load: 0.9 kN, and downward direction load: 0.3 kN) was given thereto at a frequency of 3 Hz. The endurance of the transfer-molded body was evaluated in accordance with the number of times of the vibration when a crack grew in this body so that the spring was reduced into a half of the initial value. About the evaluation of each of Examples 7 to 10, and Comparative Example 6, the result thereof was represented as an index relative to the result of Comparative Example 6, which was regarded as 100, to make index evaluations. About each of Examples 11 and 12, the result thereof was represented as an index relative to the result of Comparative Example 7, which was regarded as 100, to make index evaluations. It is meant that as the index is larger, the vulcanized rubber is better in endurance.

TABLE 2

| Compar- | | | | | Compar- | | |
|---|---|---|---|---|---|---|---|
| ative | | | | | ative | | |
| Example | Example | Example | Example | Example | Example | Example | Example |
| 6 | 7 | 8 | 9 | 10 | 7 | 11 | 12 |

(Blend)

| | | | | | | | | |
|---|---|---|---|---|---|---|---|---|
| NR | 100 | 100 | 100 | 100 | 100 | 70 | 70 | 70 |
| BR | | | | | | 30 | 30 | 30 |
| CB FEF (N550) | 40 | 40 | 40 | 40 | 40 | | | |
| CB HAF (N339) | | | | | | 40 | 40 | 40 |
| Compound | | 0.3 | 1 | 1.5 | 3 | | 0.5 | 2 |
| represented by | | | | | | | | |
| formula (I) | | | | | | | | |
| Zinc oxide | 5 | 5 | 5 | 5 | 5 | 5 | 5 | 5 |
| Stearic acid | 2 | 2 | 2 | 2 | 2 | 2 | 2 | 2 |
| Wax | 1.5 | 1.5 | 1.5 | 1.5 | 1.5 | 1.5 | 1.5 | 1.5 |
| Antiaging | 2 | 2 | 2 | 2 | 2 | 2 | 2 | 2 |
| agent 6C | | | | | | | | |
| Antiaging | 1 | 1 | 1 | 1 | 1 | 1 | 1 | 1 |
| agent RD | | | | | | | | |
| Sulfur | 0.8 | 0.8 | 0.8 | 0.8 | 0.8 | 0.8 | 0.8 | 0.8 |
| Vulcanization | 2 | 2 | 2 | 2 | 2 | 2 | 2 | 2 |
| promoter CZ | | | | | | | | |
| Vulcanization | 0.5 | 0.5 | 0.5 | 0.5 | 0.5 | 0.5 | 0.5 | 0.5 |
| promoter TS | | | | | | | | |

(Evaluations)

| | | | | | | | | |
|---|---|---|---|---|---|---|---|---|
| Dynamic | 100 | 97 | 95 | 92 | 89 | 100 | 97 | 92 |
| magnification | | | | | | | | |
| Endurance | 100 | 102 | 105 | 107 | 110 | 100 | 104 | 107 |

The results are as shown in Table 2. In each of Examples 7 to 12, which was yielded by adding the compound represented by the formula (I) to Comparative Example 6 or 7, which was a control, the vulcanized rubber was decreased in dynamic magnification, and further was improved in endurance.

What is claimed is:

1. A rubber composition for vibrationproof rubber that comprises a natural rubber wet masterbatch comprising one or more natural rubbers and one or more carbon blacks in an amount of 5 to 100 parts by mass for 100 parts by mass of the natural rubber(s), and
the rubber composition comprising a compound represented by the following formula (I) in an amount of 0.1 to 5 parts by mass when a total amount of one or more rubber components that is/comprise the natural rubber(s) is regarded as 100 parts by mass: 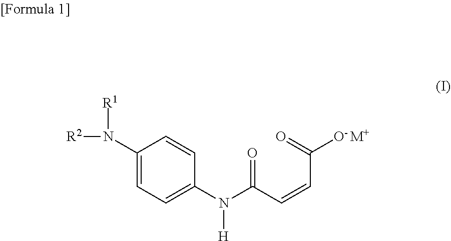
in which R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

2. The rubber composition for vibrationproof rubber according to claim 1, comprising the natural rubber(s) that is/are a natural rubber derived from the natural rubber wet masterbatch in a proportion of 10% or more by mass when the total amount of the rubber component(s) is regarded as 100% by mass.

3. The vibrationproof rubber according to claim 1, comprising the carbon black(s) that is/are carbon black derived from the natural rubber wet masterbatch in a proportion of 15% or more by mass when a total amount of the carbon black(s) is regarded as 100% by mass.

4. A vibrationproof rubber obtained by vulcanizing and molding the rubber composition recited in claim 1 for vibrationproof rubber.

5. A method for producing a rubber composition for vibrationproof rubber that comprises a natural rubber wet masterbatch yielded by using, as raw materials, at least the following: one or more carbon blacks, a dispersing solvent, and a natural rubber latex solution,
the method comprising a step (i) of adding, when the carbon black(s) is/are dispersed into the dispersing solvent, at least one portion of the natural rubber latex solution to the dispersing solvent to produce a carbon-black-containing slurry solution in which natural rubber latex particles adhere to the carbon black(s);
a step (ii) of mixing the slurry solution with a rest of the natural rubber latex solution to produce a carbon-black-containing rubber latex solution in which the natural rubber latex particles adhere to the carbon black(s),
a step (iii) of solidifying and drying the carbon-black-containing rubber latex solution, in which the natural rubber latex particles adhere to the carbon black(s), to produce the natural rubber wet masterbatch, and
a step (iv) of dry-mixing the natural rubber wet masterbatch with a blending agent that may be of various types,
wherein a compound represented by the following formula (I) is blended into the present rubber-composition-producing material-system in at least one of the steps (i) to (iv) in an amount of 0.1 to 5 parts by mass when a total amount of one or more rubber components that is/comprise one or more natural rubbers in the natural rubber wet masterbatch is regarded as 100 parts by mass: 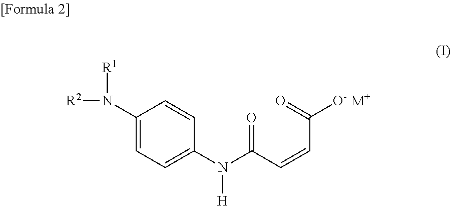
wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

6. A rubber composition for vibrationproof rubber, comprising one or more rubber components, wherein when a total amount of the rubber component(s) is regarded as 100 parts by mass, a natural rubber is comprised in an amount of 60 parts or more by mass, and further a compound represented by the following formula (I) is comprised in an amount of 0.1 to 5 parts by mass: 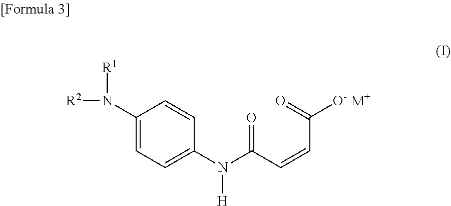
wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

7. A vibrationproof rubber, obtained by vulcanizing and molding the rubber composition for vibrationproof rubber recited in claim 1.
